(19) United States
(12) Patent Application Publication
(10) Pub. No.: US 2026/0303143 A1
(43) Pub. Date: Oct. 1, 2026

(54) METHODS AND APPARATUS FOR IMAGE REJECTION CALIBRATION

(71) Applicant: Silicon Laboratories Inc., Austin, TX (US)

(72) Inventors: Qing Li, Austin, TX (US); Yan Zhou, Spicewood, TX (US)

(21) Appl. No.: 19/090,724

(22) Filed: Mar. 26, 2025

(51) Int. Cl. H04B 1/48; H04B 17/21; H04J 1/12

(52) U.S. Cl. CPC H04B 1/48; H04B 17/221; H04J 1/12

(57) ABSTRACT

In one embodiment, a method includes: injecting, into a transmit path of a transceiver, a tone signal, the transmit path including an image rejection circuit; looping back the tone signal, from the transmit path to a receive path of the transceiver, and measuring a first plurality of digital values from the looped back tone signal while a quadrature portion of the transmit path is disconnected; looping back the tone signal, from the transmit path to the receive path, and measuring a second plurality of digital values from the looped back tone signal while an in-phase portion of the transmit path is disconnected; determining a gain calibration value for the image rejection circuit based at least in part on the first plurality of digital values and the second plurality of digital values; and storing the gain calibration value in a storage.

### BACKGROUND

Many receivers include an in-phase/quadrature phase (I/Q) transmitter architecture, in which a signal is simultaneously applied to an I-channel mixer and a Q-channel mixer. A local oscillator (LO) signal is also applied to the mixers to effect frequency conversion from a lower frequency signal to radio frequency (RF). In an I/Q transmitter, the LO signal that is applied to the Q-channel mixer is offset by 90° from the LO signal that is applied to the I-channel mixer.

In a typical transmitter architecture, mismatch between in-phase and quadrature phase paths causes image interference cross-talk. This image interference can be at least reduced using image rejection (IR) circuitry, and image rejection is one metric by which transmitter system performance may be evaluated. In general, image rejection refers to the ability of the transmitter to reject responses resulting from signals at a frequency offset from the desired RF carrier frequency. Current IR mechanisms may be insufficient to adequately resolve IR, particularly in low power wireless systems such as Bluetooth Low Energy communications, which call for relatively stringent image rejection performance.

### SUMMARY OF INVENTION

In one aspect, a method includes: injecting, into a transmit signal processing path of a transceiver, a tone signal, the transmit signal processing path comprising an image rejection circuit; looping back the tone signal, from the transmit signal processing path to a receive signal processing path of the transceiver, and measuring a first plurality of digital values from the looped back tone signal while a quadrature portion of the transmit signal processing path is disconnected; looping back the tone signal, from the transmit signal processing path to the receive signal processing path, and measuring a second plurality of digital values from the looped back tone signal while an in-phase portion of the transmit signal processing path is disconnected; determining a gain calibration value for the image rejection circuit based at least in part on the first plurality of digital values and the second plurality of digital values; and storing the gain calibration value in a storage.

In one implementation, the method further includes: looping back the tone signal, from the transmit signal processing path to the receive signal processing path, and measuring a third plurality of digital values from the looped back tone signal, while the in-phase portion and the quadrature portion are connected; and determining a phase calibration value for the image rejection circuit based at least in part on the third plurality of digital values. The method may further comprise determining the phase calibration value independently of the gain calibration value.

In an implementation, determining the phase calibration value comprises, iteratively: setting at least one most significant bit of the phase calibration value to a predetermined value; and measuring one of the third plurality of digital values from the looped back tone signal. Determining the phase calibration value may further include: setting the at least one most significant bit of the phase calibration value to the predetermined value associated with a lowest one of the third plurality of digital values; and iteratively setting least significant bits of the phase calibration value to a given value and measuring one of a fourth plurality of digital values from the looped back tone signal. Determining the phase calibration value may further comprise setting the least significant bits of the phase calibration value to the given value associated with a lowest one of the fourth plurality of digital values.

In an implementation, the method further comprises: filtering, in the receive signal processing path, a signal portion of the looped back tone signal when measuring the first plurality of digital values and the second plurality of digital values; and filtering, in the receive signal processing path, an image portion of the looped back tone signal when measuring the third plurality of digital values. The method may also include dynamically determining the gain calibration value and the phase calibration value during the field operation of the transceiver, which may occur in response to a temperature of the transceiver exceeding a threshold.

In an implementation, determining the gain calibration value, for each bit of the gain calibration value, comprises: comparing a value of the first plurality of digital values to a value of the second plurality of digital values; and setting the bit of the gain calibration value based on the comparing.

In another aspect, an apparatus includes a transmit signal processing path and a receive signal processing path. The transmit signal processing path may include: an image rejection circuit to perform image rejection on a baseband signal, the image rejection circuit comprising at least one gain correction element to be controlled based on a gain compensation value and at least one phase correction element to be controlled based on a phase compensation value; a modulator coupled to the image rejection circuit to modulate the baseband signal into a modulated baseband signal; a first switch to couple the modulated baseband signal to a first digital-to-analog converter (DAC) of an in-phase path, the first DAC to convert the modulated baseband signal to a first analog signal; a second switch to couple the modulated baseband signal to a second DAC of a quadrature path, the second DAC to convert the modulated baseband signal to a second analog signal; a first complex mixer coupled to the first DAC and the second DAC, the first complex mixer to upconvert the first analog signal to a first radio frequency (RF) signal and to upconvert the second analog signal to a second RF signal; and a combiner to combine the first RF signal and the second RF signal into a complex RF signal. The receive signal processing path may include: a second complex mixer to downconvert the complex RF signal into a first loopback analog signal and a second loopback analog signal; a digitizer to convert the first loopback analog signal to a first loopback digital signal and to convert the second loopback analog signal to a second loopback digital signal; and at least one digital circuit coupled to the digitizer, the at least one digital circuit to generate a digital value based on the first loopback digital signal and the second loopback digital signal. The apparatus may further include a controller coupled to the transmit signal processing path and the receive signal processing path. During an image rejection calibration routine, the controller may be configured to cause the second switch to disconnect the quadrature path and cause the at least one digital circuit to measure a first plurality of digital values based on the digital value.

In one implementation, the controller, during the image rejection calibration routine, is further to cause the first switch to disconnect the in-phase path and cause the at least one digital circuit to measure a second plurality of digital values based on the digital value. The controller may determine the gain compensation value based on a comparison of the first plurality of digital values to the second plurality of digital values. The controller may further determine the phase compensation value during the image rejection calibration routine.

In an implementation, the controller is to cause the first switch to connect the in-phase path and cause the second switch to connect the quadrature path to enable the controller to determine the phase compensation value. The controller may be configured to cause a filter of the receive signal processing path to filter a signal portion of the first loopback digital signal and the second loopback digital signal while the first plurality of digital values and the second plurality of digital values are measured.

In yet another aspect, a method includes: injecting, into a transmit signal processing path of the wireless device, a tone signal, the transmit signal processing path comprising an image rejection circuit; looping back the tone signal, from the transmit signal processing path to a receive signal processing path of the wireless device, and measuring a first plurality of digital values from the looped back tone signal while a quadrature portion of the transmit signal processing path is disconnected; looping back the tone signal, from the transmit signal processing path to the receive signal processing path, and measuring a second plurality of digital values from the looped back tone signal while an in-phase portion of the transmit signal processing path is disconnected; determining a gain calibration value for the image rejection circuit based at least in part on the first plurality of digital values and the second plurality of digital values; determining a phase calibration value for the image rejection circuit; and storing the gain calibration value and the phase calibration value in a storage of the wireless device.

In one implementation, the method further comprises dynamically determining the gain calibration value and the phase calibration value during field operation of the wireless device, in response to a sensor value of the wireless device exceeding a threshold. The method may also include performing image rejection of a baseband signal in the image rejection circuit using the gain calibration value and the phase calibration value. Determining the gain calibration value, for each bit of the gain calibration value, may include: comparing a value of the first plurality of digital values to a value of the second plurality of digital values; and setting the bit of the gain calibration value based on the comparing.

In one example, a computer-readable storage medium includes instructions to perform the methods described above. In another example, a computer-readable storage medium including data is to be used by at least one machine to fabricate at least one integrated circuit to perform the methods described above. In yet another example, an apparatus comprises means for performing the methods described above.

### BRIEF DESCRIPTION OF THE DRAWINGS

FIG. 1 is a block diagram of an apparatus in accordance with an embodiment.

FIG. 2 is a schematic diagram of an IR circuit in accordance with an embodiment.

FIG. 3 is a flow diagram of a method in accordance with an embodiment.

FIG. 4 is a flow diagram of a method in accordance with another embodiment.

FIG. 5 is a flow diagram of a method in accordance with yet another embodiment.

FIG. 6 is a block diagram of a representative integrated circuit in accordance with an embodiment.

FIG. 7 is a high level diagram of a network in accordance with an embodiment.

### DETAILED DESCRIPTION

In various embodiments, an image rejection (IR) circuit of a wireless transmitter can be calibrated at high accuracy with minimal calibration time. For example, in one implementation, this IR calibration can be used to achieve image rejection performance of −45 decibels (dB), and may be performed in a calibration time of less than approximately 500 microseconds (μs). As will be described herein, such IR calibration may proceed in separate phases in which a gain imbalance determination proceeds in a decoupled and independent manner from a phase imbalance determination. Also understand that IR calibration may be performed both during product manufacturing such as during production testing, as well as during in field use of the wireless transceiver.

At a high level, IR calibration may be efficiently performed by injecting a tone signal into a transmit signal processing path, looping back a resulting radio frequency (RF) signal from the transmit signal processing path to a receive signal processing path. This receive signal processing path processes this looped back signal in the manner described herein to obtain complex digital amplitude signals, which can be further processed to determine the IR compensation values. In turn, these IR compensation values are provided to the IR circuit of the transmit signal processing path for use in performing image rejection.

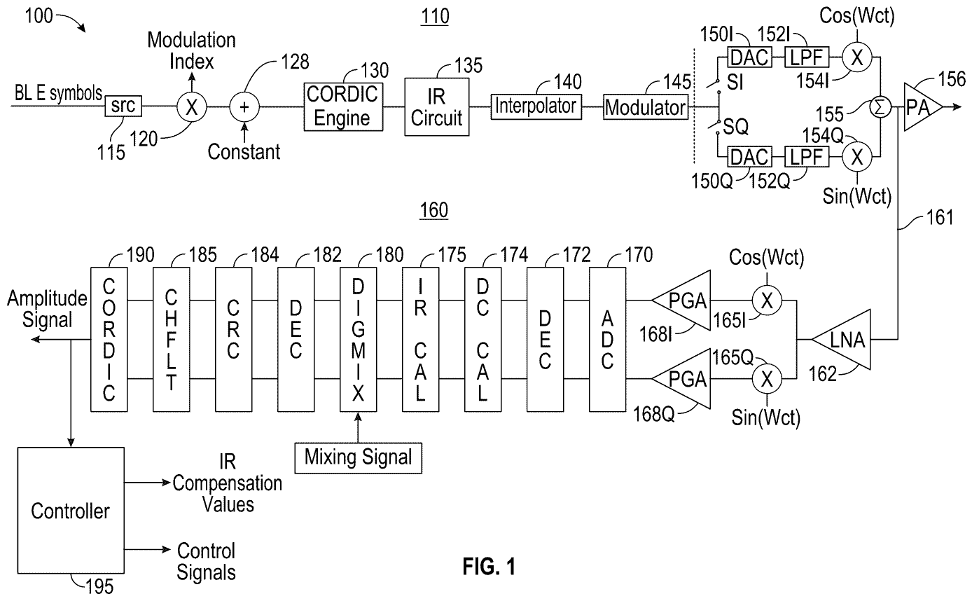

Referring now to FIG. 1, shown is a block diagram of an apparatus in accordance with an embodiment. More specifically, as shown in FIG. 1, apparatus 100 is part of a transceiver, including a transmit signal processing path 110 and a receive signal processing path 160, along with a controller 195. In various implementations, transceiver 100 may be a single or multi-protocol wireless transceiver. For purposes of discussion, the IR calibration described herein is in the context of a Bluetooth Low Energy (BLE) wireless protocol; however, understand that embodiments are not limited in this regard, and the IR calibration techniques described herein can be used for other wireless protocols.

Referring first to transmit signal processing path 110, incoming symbols, e.g., BLE symbols generated in a baseband processor, are provided to a sample rate converter (SRC) 115. The resulting sample rate-converted symbols are processed in a multiplier 120 according to a modulation index. In turn, a tone signal can be injected via an adder 128. In embodiments, this tone signal may be generated by injection of a constant value, which may generate a DC tone for purposes of performing the IR calibration described herein. In a particular embodiment, this DC tone signal may be injected at a frequency of 1 MHz, to minimize phase noise impact (with an image at −1 MHz). Understand that during normal transmitter operations, this tone signal is not injected.

Still referring to FIG. 1, the signal is provided to a coordinate rotation digital computer (CORDIC) engine 130. CORDIC engine 130 may generate amplitude and phase signals based on the input signal and provide them to an IR circuit 135. Although shown at a high level in the embodiment of FIG. 1, understand that IR circuit 135 more generally may be used to perform various signal processing, including IQ imbalance compensation, gain control and DC offset correction. The resulting processed signals are provided to an interpolator 140 that in turn is coupled to a modulator 145. In one or more embodiments, modulator 145 may be implemented as a sigma delta modulator (SDM), e.g., a first-order SDM.

Still referring to FIG. 1, the modulated signals are provided to separate complex signal processing paths, namely, an I path and a Q path. As shown, modulator 145 couples to corresponding digital-to-analog converters (DACs) 1501, Q. Note presence of switches SI and SQ. As will be described herein, these switches, which may normally remain closed during normal transmit operations, may be controlled during IR calibration operation to selectively pass only a given one of the I and Q signals.

The resulting analog signals output from DACs 150 are provided to corresponding low path filters (LPFs) 152_{I,Q}. In turn, the filtered signals are upconverted to an RF frequency via a complex mixer 154_{I,Q}. The separate complex signals, in turn, are combined in a summer 155 and may be transmitted via a power amplifier (PA) 156.

Still referring to FIG. 1, a loopback path 161 couples from the output of summer 155 to receive signal processing path 160, more specifically, to a low noise amplifier (LNA) 162. Note that loopback path 161 may be enabled for purposes of performing IR calibration and/or other calibration operations. Understand that in normal transmission scenarios, however, transmission path 161 may be disabled.

As illustrated, LNA 162 couples to a complex mixer 165_{I,Q}, which downconverts the loopback RF signal to a lower frequency signal (e.g., an intermediate frequency (IF), zero IF (ZIF), near-IF or baseband signal). The resulting lower frequency complex signals are amplified in a programmable gain amplifier (PGA) 168_{I,Q}, and are then digitized in an analog-to-digital converter (ADC) 170. As further illustrated, various digital signal processing, including decimation, DC calibration, receive IR calibration, digital mixing, and further decimation, sample rate conversions and channel filtering may occur in one or more of blocks 172, 174, 175, 180, 182, 184 and 185. Although embodiments are not limited in this regard, in one implementation, decimation may be by a factor of 24, and the channel filter may be set at approximately 200 kHz.

As illustrated in FIG. 1, digital mixer 180 may receive a mixing signal, which for purposes of IR calibration may be an image/signal tone signal to cause digital mixer 180 to downconvert the incoming signal to DC. As further illustrated in FIG. 1, a CORDIC engine 190 may generate digital amplitude signals which, during normal reception operations, may be passed to further processing, e.g., such as demodulation or so forth.

For IR calibration, these amplitude signals are provided to a controller 195. Controller 195 may further process these digital amplitude values to obtain IR compensation values that can be provided to IR circuit 135. Still further, controller 195 may control IR calibration operations by appropriate control of various points of the signal processing paths, including switches SI, SQ and loopback path 161, as will be described further herein. Although shown at this high level in the embodiment of FIG. 1, many variations and alternatives are possible.

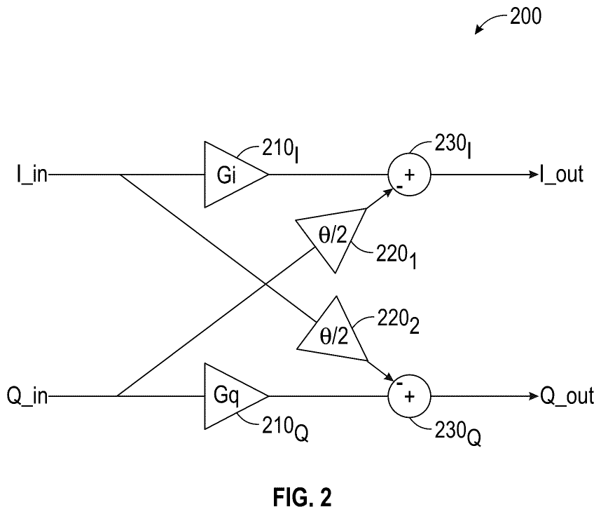

Referring now to FIG. 2, shown is a schematic diagram of an IR circuit in accordance with an embodiment. As shown in FIG. 2, IR circuit 200 is a transmit image rejection circuit and may be implemented at a given point in a transmit signal processing path, e.g., such as shown in FIG. 1 as IR circuit 135.

As illustrated in FIG. 2, IR circuit 200 includes gain compensation elements 210_{I,Q}, each of which is coupled on a given complex path to apply gain compensation according to a gain compensation value. In the embodiment of FIG. 2, IR circuit 200 may be configured to realize image rejection of at least approximately −45 dB. IR circuit 200 may operate in accordance with Equations 1 and 2.

$$Y = {Y}_{i} + {jY}_{q} , α = \frac{ε}{2} + j \frac{θ}{2} , \qquad ( Eq . 1 )$$

where Y is a complex IQ signal (formed of in-phase component Yᵢ and quadrature phase component Y_{q}), ε is gain imbalance, θ is phase imbalance, and Y* is a complex conjugate of Y.

$$IQ imbalance correction \to \hat{Y} = Y - α {Y}^{*} \qquad ( Eq . 2 )$$

In some embodiments, coefficients G_{I} and G_{Q} may be set to, respectively, Gᵢ=1−ε/2, G_{q}=1+ε/2, according to a determined gain compensation value. As shown, gain compensation elements 210 couple to corresponding summers 230_{I,Q}, which combine the signal with a phase correction received from the cross-coupled path via corresponding phase compensation elements 220_{1,2}. In an embodiment, coefficient θ may be set to a value according to a determined phase compensation value. The resulting image rejected signals are output for further transmit signal path processing. Although shown at this high level in the embodiment of FIG. 2, many variations and alternatives are possible.

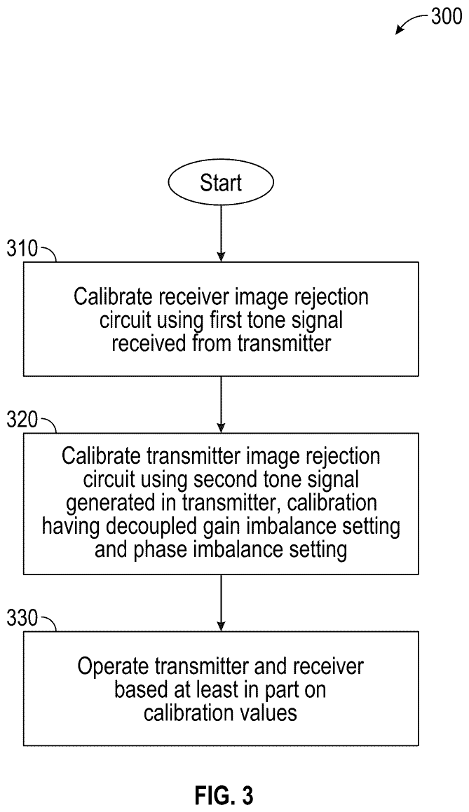

Referring now to FIG. 3, shown is a flow diagram of a method in accordance with an embodiment. As shown in FIG. 3, method 300 is a method for performing IR calibration, both for a receiver and a transmitter, and operating these transceiver components based on the calibrations. Method 300 may be performed by hardware circuitry, such as various circuitry shown in FIG. 1 alone and/or in combination with firmware and/or software.

In different use cases, method 300 may be performed during manufacturing testing, e.g., to determine baseline compensation values (which may be stored in a non-volatile memory) and during in field operation, such as may be triggered when a given sensor indicates a change in an environmental parameter that exceeds a threshold. As one concrete example, assume that the wireless transceiver is incorporated into a smart bulb. The temperature of the smart bulb may vary significantly depending on whether the bulb is active and/or intensity at which it operates. In an embodiment, a temperature sensor may identify when the temperature exceeds a given threshold, which may trigger an IR calibration operation to be performed to update gain and/or phase compensation values. It is also possible to control IR calibration to be performed according to a predetermined schedule in the absence of a trigger such as a given environmental parameter exceeding one or more thresholds. Further, with embodiments that reduce search space and perform IR calibration at high precision and high speed, less interference with regular wireless operations is realized.

As illustrated, method 300 begins by calibrating a receiver image rejection circuit using a first tone signal received from the transmitter (block 310). This tone signal may be a DC signal that can be injected into the transmit signal processing path. After this calibration completes, next at block 320 the transmit image rejection circuit can be calibrated using another tone signal generated in the transmitter. This transmit IR calibration can be performed with decoupled gain imbalance and phase imbalance determinations.

Upon completion of these calibrations, at block 330 the transmitter and receiver can be operated based at least in part on these calibration values. For example, as discussed above with regard to FIG. 2, the transmit IR calibration results in gain and phase compensation values that are applied to the transmit IR circuit. Although shown at this high level in the embodiment of FIG. 3, many variations and alternatives are possible.

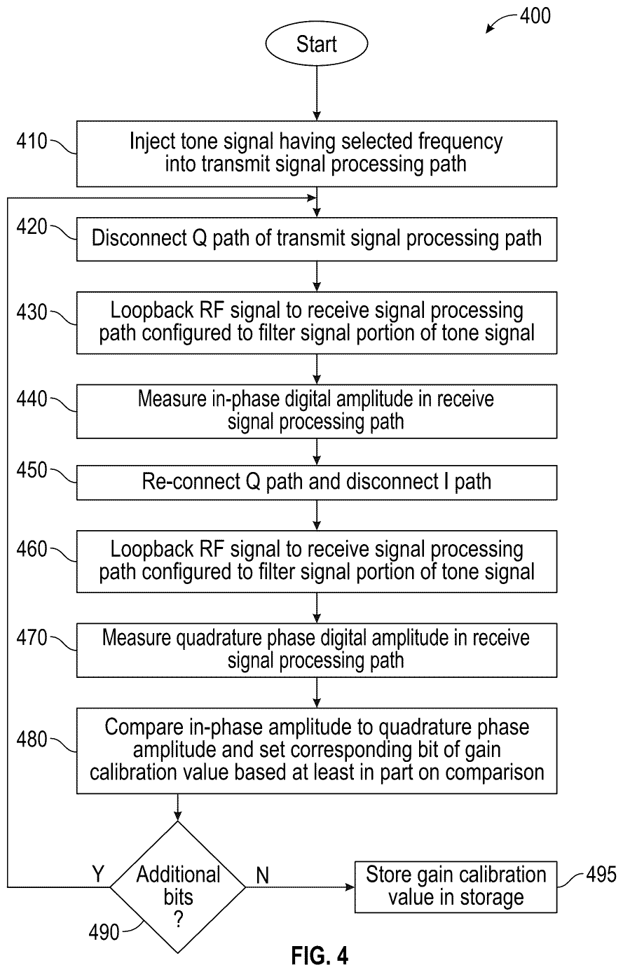

Referring now to FIG. 4, shown is a flow diagram of a method in accordance with another embodiment. As shown in FIG. 4, method 400 is a more detailed method for performing a gain compensation determination of a transmit IR calibration. Method 400 may be performed by hardware circuitry, such as the circuitry shown in FIG. 1 alone and/or in combination with firmware and/or software.

As illustrated, method 400 begins by injecting a tone signal having a selected frequency into the transmit signal processing path (block 410). In an embodiment, the tone signal may be a DC tone (e.g., injected at a frequency of 1 MHz). Next at block 420, the Q path is disconnected. With reference back to FIG. 1, switch SQ may be opened to disconnect this Q path. Then at block 430, the RF signal is looped back to the receive signal processing path, which is configured to filter a signal portion of the tone signal. Note that additional configuring of the receive signal processing path also may occur, such as setting a digital mixer shift to a given frequency (e.g., 1 MHz). Then at block 440, an in-phase digital amplitude output from the receive signal processing path (e.g., a CORDIC engine output) is measured.

Still referring to FIG. 4, similar operations may proceed with the in-phase path of the transmit signal processing path disconnected. Thus as shown in FIG. 4, similar operations proceed at blocks 450, 460 and 470. Then at block 480, the in-phase amplitude is compared to the quadrature phase amplitude. Based at least in part on this comparison, a given bit of a gain calibration value is set. In one implementation, if the in-phase value is greater than the quadrature phase value (Amp_I>Amp_Q), the bit is set high, otherwise it is set low. Thus method 400 shows a bit-by-bit determination of the gain calibration value. If additional bits are to be determined, as identified at diamond 490, control passes back to block 420. Otherwise, at block 495 the final gain calibration value may be stored in a storage, e.g., a calibration storage such as may be present within a controller or IR circuit. In one embodiment a 6-bit gain calibration value is obtained, incurring twelve measurements. Although shown at this high level in the embodiment of FIG. 4, many variations and alternatives are possible.

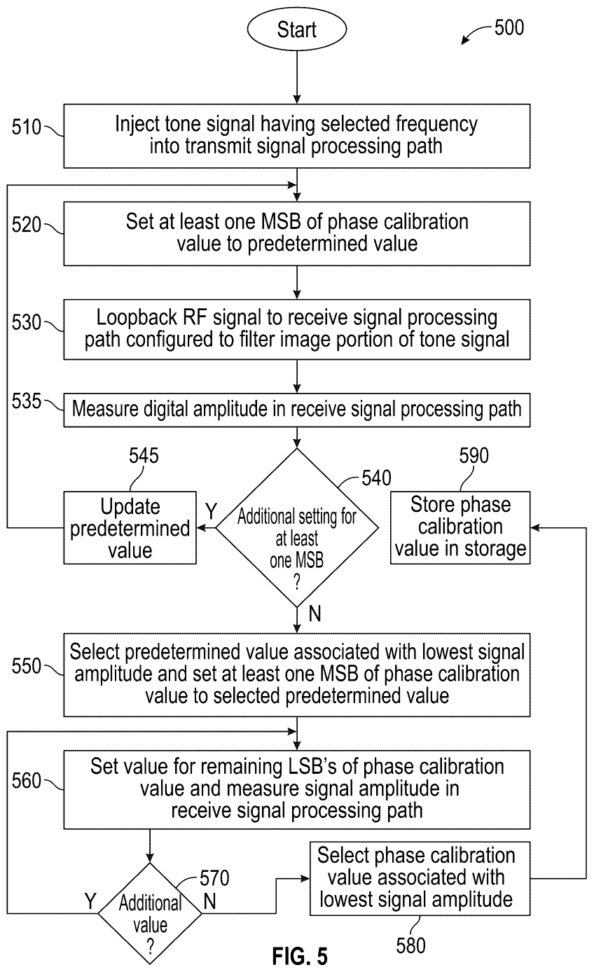

Referring now to FIG. 5, shown is a flow diagram of a method in accordance with yet another embodiment. As shown in FIG. 5, method 500 is a more detailed method for performing a phase compensation determination of a transmit IR calibration. Method 500 may be performed by hardware circuitry, such as the circuitry shown in FIG. 1 alone and/or in combination with firmware and/or software.

As illustrated, method 500 begins by injecting a tone signal having a selected frequency, e.g., a DC tone (injected at a frequency of 1 MHz), into the transmit signal processing path (block 510). As further shown, at block 520, at least one most significant bit (MSB) of a phase calibration value can be set to a predetermined value. For purposes of discussion, assume that two MSBs are set to a given value, and that this predetermined value is 00. Thereafter, at block 530, the RF signal is looped back to the receive signal processing path, still configured to filter the signal portion of the tone signal. Note that additional configuring of the receive signal processing path also may occur, such as setting a digital mixer shift to a given frequency (e.g., 1 MHz). Then at block 535, a digital amplitude output from the receive signal processing path (e.g., a CORDIC engine output) is measured, and an exhaustive search is performed for the remaining LSBs. Then it is determined whether there are additional settings available for these two MSBs (as determined at diamond 540). If so, at block 545, the predetermined value is updated (e.g., proceeding from 00, 01, 10 and 11).

Once all of these digital amplitudes are measured for the iterations of this loop, control passes to block 550. At block 550, the given one of these predetermined values associated with a lowest signal amplitude is selected and is set to be the at least one MSB of the phase calibration value. Thereafter, at block 560, a successive approximation (SAR) search may be performed for the remaining bits (e.g., 4 LSBs in the context of a 6-bit phase calibration value). Such values are iteratively set and the signal amplitude is measured. Once all values have been searched (as determined at diamond 570), control passes to block 580. At block 580, a phase calibration value associated with the lowest signal amplitude may be selected and stored, e.g., in a calibration storage as the phase calibration value (block 590).

Thus in FIG. 5, for these remaining LSBs, an exhaustive search is performed for one or more MSBs, and then a SAR search is performed for the remaining bits to determine a minimum image, and the corresponding value is chosen as the phase calibration value. In an embodiment a 6-bit phase calibration value is obtained, and the phase calibration may incur 32 measurements. Although shown at this high level in the embodiment of FIG. 5, many variations and alternatives are possible.

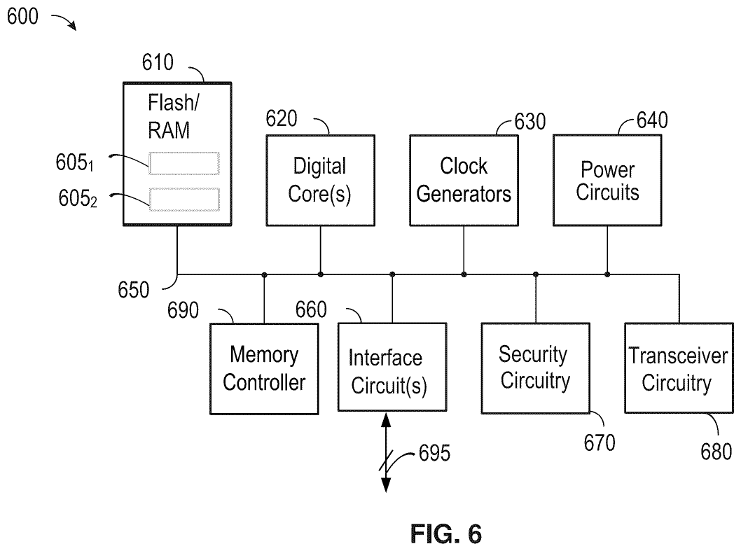

Referring now to FIG. 6, shown is a block diagram of a representative integrated circuit 600 that includes IR circuitry as described herein. In the embodiment shown in FIG. 6, integrated circuit 600 may be, e.g., a multi-mode wireless transceiver that may operate according to one or more wireless protocols or other device that can be used in a variety of use cases. In one or more embodiments, the circuitry of integrated circuit 600 shown in FIG. 6 may be implemented on a single semiconductor die or implemented on separate dies for wireless communication, MCU compute, external flash and/or other IP blocks needed to perform various functionalities.

Integrated circuit 600 may be included in a range of devices, but for purposes of discussion, it may be incorporated into an IoT device. In the embodiment shown, integrated circuit 600 includes a memory system 610 which in an embodiment may include volatile storage, such as RAM and non-volatile memory such as a flash memory. The flash memory is a non-transitory storage medium that can store instructions and data. These instructions include a set of instructions that, when executed, control signal processing paths to perform IR calibration as described herein.

As further shown in FIG. 6, memory system 610 may store code 6051 having instructions that when executed cause control circuitry to configure the signal processing paths to perform an IR calibration routine as described herein. As further shown, memory 610 includes a configuration storage 6052 to store gain and phase compensation values for performing image rejection, determined using an IR calibration process as described herein. Integrated circuit 600 also may include a memory controller 690.

Memory system 610 couples via a bus 650 to one or more digital cores 620, which may include one or more cores and/or microcontrollers that act as processing units of the integrated circuit, and which may control IR calibration operations as described herein. In turn, digital cores 620 may couple to clock generators 630 which may provide one or more phase locked loops or other clock generator circuitry to generate various clocks for use by circuitry of the IC.

As further illustrated, IC 600 also includes power circuitry 640. Additional circuitry may be present depending on particular implementation to provide various functionality and interaction with external devices. Such circuitry may include interface circuitry 660 which provides a digital communication interface with additional circuitry (such as another IC that can couple to IC 600 via a link 695). IC 600 also may include security circuitry 670 to perform wireless security techniques.

In addition, as shown in FIG. 6, transceiver circuitry 680 may be provided to enable transmission and reception of wireless signals, e.g., according to one or more of a local area or wide area wireless communication scheme, such as Matter, Zigbee, Bluetooth, BLE, IEEE 802.11, IEEE 802.15.4, cellular communication or so forth. Understand while shown with this high level view, many variations and alternatives are possible.

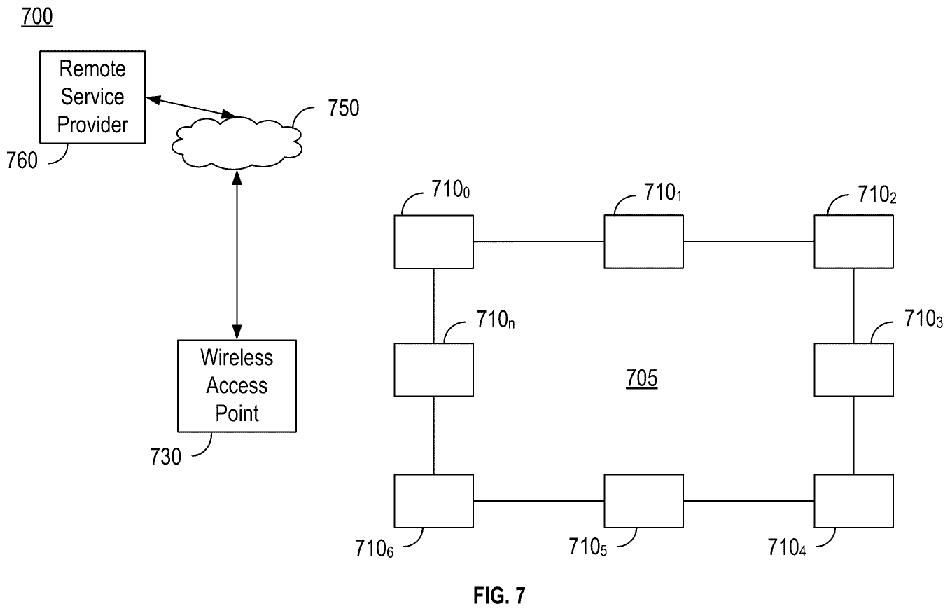

ICs such as described herein may be implemented in a variety of different devices as described above. Referring now to FIG. 7, shown is a high level diagram of a network in accordance with an embodiment. As shown in FIG. 7, a network 700 includes a variety of devices, including IoT and other wireless devices that may perform IR calibration as described herein.

In the embodiment of FIG. 7, a wireless mesh network 705 is present, e.g., in a building having multiple wireless devices 7100-n. As shown, wireless devices 710, which may be IoT or other wireless devices, couple to an access point 730 that in turn communicates with a remote service provider 760 via a wide area network 750, e.g., the Internet. Understand while shown at this high level in the embodiment of FIG. 7, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
injecting, into a transmit signal processing path of a transceiver, a tone signal, the transmit signal processing path comprising an image rejection circuit;
looping back the tone signal, from the transmit signal processing path to a receive signal processing path of the transceiver, and measuring a first plurality of digital values from the looped back tone signal while a quadrature portion of the transmit signal processing path is disconnected;
looping back the tone signal, from the transmit signal processing path to the receive signal processing path, and measuring a second plurality of digital values from the looped back tone signal while an in-phase portion of the transmit signal processing path is disconnected;
determining a gain calibration value for the image rejection circuit based at least in part on the first plurality of digital values and the second plurality of digital values; and
storing the gain calibration value in a storage.

2. The method of claim 1, further comprising:
looping back the tone signal, from the transmit signal processing path to the receive signal processing path, and measuring a third plurality of digital values from the looped back tone signal, while the in-phase portion and the quadrature portion are connected; and
determining a phase calibration value for the image rejection circuit based at least in part on the third plurality of digital values.

3. The method of claim 2, further comprising determining the phase calibration value independently of the gain calibration value.

4. The method of claim 2, wherein determining the phase calibration value comprises, iteratively:
setting at least one most significant bit of the phase calibration value to a predetermined value; and
measuring one of the third plurality of digital values from the looped back tone signal.

5. The method of claim 4, wherein determining the phase calibration value further comprises:
setting the at least one most significant bit of the phase calibration value to the predetermined value associated with a lowest one of the third plurality of digital values; and
iteratively setting least significant bits of the phase calibration value to a given value and measuring one of a fourth plurality of digital values from the looped back tone signal.

6. The method of claim 5, wherein determining the phase calibration value further comprises setting the least significant bits of the phase calibration value to the given value associated with a lowest one of the fourth plurality of digital values.

7. The method of claim 2, further comprising:
filtering, in the receive signal processing path, a signal portion of the looped back tone signal when measuring the first plurality of digital values and the second plurality of digital values; and
filtering, in the receive signal processing path, an image portion of the looped back tone signal when measuring the third plurality of digital values.

8. The method of claim 2, further comprising dynamically determining the gain calibration value and the phase calibration value during field operation of the transceiver.

9. The method of claim 8, further comprising dynamically determining the gain calibration value and the phase calibration value during the field operation of the transceiver, in response to a temperature of the transceiver exceeding a threshold.

10. The method of claim 1, wherein determining the gain calibration value, for each bit of the gain calibration value, comprises:
comparing a value of the first plurality of digital values to a value of the second plurality of digital values; and
setting the bit of the gain calibration value based on the comparing.

11. An apparatus comprising:
a transmit signal processing path comprising:
an image rejection circuit to perform image rejection on a baseband signal, the image rejection circuit comprising at least one gain correction element to be controlled based on a gain compensation value and at least one phase correction element to be controlled based on a phase compensation value;
a modulator coupled to the image rejection circuit to modulate the baseband signal into a modulated baseband signal;
a first switch to couple the modulated baseband signal to a first digital-to-analog converter (DAC) of an in-phase path, the first DAC to convert the modulated baseband signal to a first analog signal;
a second switch to couple the modulated baseband signal to a second DAC of a quadrature path, the second DAC to convert the modulated baseband signal to a second analog signal;
a first complex mixer coupled to the first DAC and the second DAC, the first complex mixer to upconvert the first analog signal to a first radio frequency (RF) signal and to upconvert the second analog signal to a second RF signal; and
a combiner to combine the first RF signal and the second RF signal into a complex RF signal;
a receive signal processing path comprising:
a second complex mixer to downconvert the complex RF signal into a first loopback analog signal and a second loopback analog signal;
a digitizer to convert the first loopback analog signal to a first loopback digital signal and to convert the second loopback analog signal to a second loopback digital signal; and
at least one digital circuit coupled to the digitizer, the at least one digital circuit to generate a digital value based on the first loopback digital signal and the second loopback digital signal; and
a controller coupled to the transmit signal processing path and the receive signal processing path, wherein the controller, during an image rejection calibration routine, is to cause the second switch to disconnect the quadrature path and cause the at least one digital circuit to measure a first plurality of digital values based on the digital value.

12. The apparatus of claim 11, wherein the controller, during the image rejection calibration routine, is further to cause the first switch to disconnect the in-phase path and cause the at least one digital circuit to measure a second plurality of digital values based on the digital value.

13. The apparatus of claim 12, wherein the controller is to determine the gain compensation value based on a comparison of the first plurality of digital values to the second plurality of digital values.

14. The apparatus of claim 13, wherein the controller is further to determine the phase compensation value during the image rejection calibration routine.

15. The apparatus of claim 14, wherein the controller is to cause the first switch to connect the in-phase path and cause the second switch to connect the quadrature path to enable the controller to determine the phase compensation value.

16. The apparatus of claim 12, wherein the controller is to cause a filter of the receive signal processing path to filter a signal portion of the first loopback digital signal and the second loopback digital signal while the first plurality of digital values and the second plurality of digital values are measured.

17. A computer-readable storage medium comprising instructions that when executed by at least one processor of a wireless device cause the wireless device to perform a method comprising:
injecting, into a transmit signal processing path of the wireless device, a tone signal, the transmit signal processing path comprising an image rejection circuit;
looping back the tone signal, from the transmit signal processing path to a receive signal processing path of the wireless device, and measuring a first plurality of digital values from the looped back tone signal while a quadrature portion of the transmit signal processing path is disconnected;
looping back the tone signal, from the transmit signal processing path to the receive signal processing path, and measuring a second plurality of digital values from the looped back tone signal while an in-phase portion of the transmit signal processing path is disconnected;
determining a gain calibration value for the image rejection circuit based at least in part on the first plurality of digital values and the second plurality of digital values;
determining a phase calibration value for the image rejection circuit; and
storing the gain calibration value and the phase calibration value in a storage of the wireless device.

18. The computer-readable storage medium of claim 17, wherein the method further comprises dynamically determining the gain calibration value and the phase calibration value during field operation of the wireless device, in response to a sensor value of the wireless device exceeding a threshold.

19. The computer-readable storage medium of claim 17, wherein the method further comprises performing image rejection of a baseband signal in the image rejection circuit using the gain calibration value and the phase calibration value.

20. The computer-readable storage medium of claim 17, wherein determining the gain calibration value, for each bit of the gain calibration value, comprises:
comparing a value of the first plurality of digital values to a value of the second plurality of digital values; and
setting the bit of the gain calibration value based on the comparing.
